(19) United States
(12) Patent Application Publication
(10) Pub. No.: US 2026/0132665 A1
(43) Pub. Date: May 14, 2026

(54) SPINDLE DRIVE ASSEMBLY

(71) Applicant: Stabilus GmbH, Koblenz (DE)

(72) Inventors: Markus Reifenhäuser, Niederhofen (DE); Sebastian Schimmelpfennig, Bad Neuenahr - Ahrweiler (DE)

(21) Appl. No.: 19/375,684

(22) Filed: Oct. 31, 2025

(30) Foreign Application Priority Data
Nov. 11, 2024 (DE) 102024132873.8

(51) Int. Cl. E05F 15/622

(52) U.S. Cl. CPC E05F 15/622; E05Y 2201/702; E05Y 2900/531

(57) ABSTRACT

The present invention relates to a spindle drive assembly (10) comprising a motor assembly (12) comprising a motor shaft which can be driven in rotation by a motor and which defines a motor axis (L12), a spindle assembly (14) comprising a spindle (14a) with a spindle axis (L14), wherein the spindle (14a) is coupled to the motor shaft via a worm gear and can be driven to an extending and to a retracting movement; a first attachment assembly (16) which is designed to attach the motor assembly (12) and the spindle assembly (14) to a first higher-level assembly in a manner pivotable about a first pivot axis (22), and a second attachment assembly (32) which is arranged at one end of the spindle (14a) and is designed to attach the spindle (14a) to a second higher-level assembly in a manner pivotable about a second pivot axis (40). According to the invention, the second attachment assembly (32) is formed such that the second pivot axis (40) is spaced from the spindle axis (L14) by a predetermined offset (V).

The present invention relates to a spindle drive assembly comprising a motor assembly comprising a motor shaft which can be driven in rotation by a motor and which defines a motor axis, a spindle assembly comprising a spindle with a spindle axis, wherein the spindle is coupled to the motor shaft via a worm gear and can be driven to an extending and to a retracting movement, a first attachment assembly which is designed to attach the motor assembly and the spindle assembly to a first higher-level assembly in a manner pivotable about a first pivot axis, and a second attachment assembly which is arranged at one end of the spindle and is designed to attach the spindle to a second higher-level assembly in a manner pivotable about a second pivot axis.

It is known that in certain installation configurations of spindle drive assemblies, it must be possible to pivot them relative to the higher-level assemblies to which the motor assembly and the spindle assembly, on the one hand, and the spindle, on the other hand, are attached. Generally speaking, this applies to any pair of higher-level assemblies which are coupled to one another via a hinge connection and can be driven to pivot about the resulting hinge axis by a corresponding spindle drive assembly.

A particularly relevant case concerns door drives and the like in vehicles in which a vehicle door or, for example, a tailgate is connected in articulated fashion to a vehicle body of the corresponding vehicle by a hinge connection and is intended to be actuated or automatically pivotable by such a spindle drive assembly. Since, together with the relative pivoting of the vehicle door or flap relative to the vehicle body, the corresponding connection points of the spindle drive will also execute a curved pivoting movement, pivotability in the region of these connection points relative to the corresponding higher-level assemblies must be enabled. In other words, in a spindle drive assembly mounted in this way, each stroke position of the spindle is assigned a corresponding pivoting position thereof relative to the two higher-level assemblies, which positions are achieved with the first and the second pivoting axes.

In order to ensure this pivotability of the spindle drive assembly, the prior art has often used joint eyes for the second attachment assembly, i.e. the connection between the spindle and the second higher-level assembly, which joint eyes are located directly at the end of the spindle and therefore coincident with the spindle axis. The second pivot axis was thus formed by a bolt inserted into the joint eye and then connected to the second higher-level assembly via an angle plate that could be pivoted accordingly with respect to the spindle. In addition, in such spindle drive assemblies known from the prior art, a pivotable connection of the motor assembly and the spindle assembly via the already mentioned first attachment assembly to the first higher-level assembly was provided, wherein different approaches were pursued at this point with regard to the design of the first attachment assembly.

However, particularly in applications involving automatically actuatable vehicle doors, the available installation space for accommodating and connecting the spindle drive assembly is usually very limited. As a rule, the motor assembly and the spindle assembly are pivotably arranged in a recess in the corresponding vehicle door, and the spindle extends from this recess through an aperture, in the direction of the vehicle body. As a result, there are significant limitations both in terms of the space that can be used for the pivoting angle to be covered by the motor assembly and the spindle assembly within the corresponding vehicle door, and also in terms of the width of the door aperture in which the spindle can pivot.

The mentioned pivoting movement of the corresponding spindle drive assembly can here be influenced constructively by the position of the first and second pivot axes, wherein different approaches have already been pursued in particular with regard to the arrangement of the first pivot axis, and in some cases a pivotable mounting of the spindle itself within the spindle drive assembly relative to the motor assembly has also been implemented. In general, the pivot angle of the motor assembly and the spindle assembly on the one hand and the radius of the pivot movement of the second pivot axis around the hinge axis of the first and second higher-level assembly are proportional to each other. Accordingly, the smallest possible radius of the second pivot axis around the hinge axis between the two higher-level assemblies automatically also results in a small pivoting movement of the motor assembly and the spindle assembly within the vehicle door in such applications.

However, this advantage of a small radius of the second pivot axis around the hinge axis between the two higher-level assemblies is counteracted by the position of the required door aperture. In order to avoid a collision of the spindle here, the radius already mentioned must be chosen sufficiently large, wherein this discrepancy allows only limited control of the pivot kinematics of the drive. In addition, due to the space requirements already mentioned inside a vehicle door acting as the first higher-level assembly, it may be necessary to select a small radius around the hinge axis itself, which, however, may again lead to a collision between the spindle and the door aperture. Accordingly, it is not possible in the prior art to accommodate such a generic spindle drive assembly without structural changes to the higher-level assemblies in a vehicle.

Accordingly, there is a need for a further-developed generic spindle drive assembly in which, on the one hand, a pivot radius of the second pivot axis is minimized and, on the other hand, the installation space required in the region of the first higher-level assembly or within a vehicle door as well as the width of an aperture in this region, can be minimized.

To achieve this object and to eliminate the above-mentioned disadvantages of the known prior art, it is proposed according to the invention to further develop a generic spindle drive assembly of the type described above in such a way that the second attachment assembly is formed in such a way that the second pivot axis is spaced from the spindle axis by a predetermined offset.

Accordingly, in the spindle drive assembly according to the invention it is ensured that the second pivot axis and the spindle axis no longer intersect, whereby the installation space requirement at an aperture of the first higher-level assembly can be controlled depending on the installation space requirement inside the first higher-level assembly. Thus, by means of the offset according to the invention between the second pivot axis and the spindle axis, a smaller pivot radius around a hinge axis between the higher-level assemblies can be realized while at the same time avoiding collision of the spindle at an aperture in the first higher-level assembly.

In a particularly simple embodiment, the second attachment assembly may comprise a crank that is firmly connected to the spindle or a crank formed on the spindle, which crank defines the second pivot axis, in particular by comprising a joint eye. In particular, the second attachment assembly can here further comprise a connecting element which is pivotally connected to the crank and is designed for attachment to the second higher-level assembly, wherein a bolt can preferably be provided for the articulated connection of the connecting element to the crank, which bolt accordingly defines the second pivot axis. By designing the crank in a similar manner to a corresponding connection in spindle drive assemblies already known from the prior art, it is in principle possible to use the same or similar connecting elements for the connection to the second higher-level assembly, which means that no redesign is necessary in this region and, accordingly, already-known components and fastenings can be used to save costs.

It is also apparent that in typical applications of a connection of a spindle assembly according to the invention between a vehicle door and a vehicle body, with the dimensions of the components involved that are usual in such cases, the predetermined offset between the second pivot axis and the spindle axis can be in the range of 5 mm and 20 mm and can preferably be approximately 10 mm in order to achieve the above-described advantages of the present invention to the best extent.

Although the effect of the offset of the second pivot axis from the spindle axis can be achieved independently of the specific design of the connection of the spindle drive assembly to the first higher-level assembly, particularly advantageous kinematics can be achieved if the first pivot axis substantially coincides with the motor axis of the motor assembly, i.e. runs at least partially through a corresponding motor housing of the motor assembly in order to achieve a substantially stationary pivoting of the motor assembly and the spindle assembly in this region.

This can be achieved, inter alia, in that the first attachment assembly comprises two angle elements which can be pivoted relative to one another about the first pivot axis, a first of which is assigned to the motor assembly and the spindle assembly and a second of which is assigned to the first higher-level assembly, wherein the angle elements are connected by means of a rotary joint which is arranged substantially in extension of the motor axis on the side of the spindle assembly facing away from the motor assembly. This allows the motor assembly and spindle assembly to rotate substantially in place at their mounting position without this pivoting movement being subject to kinematic leverage.

Furthermore, in order to carry out the pivoting movement about the first pivot axis just mentioned with greater rigidity, the angle elements can additionally be coupled via a curved guide which is arranged outside the motor assembly or the spindle assembly with respect to a radial direction perpendicular to the motor axis. Such a curved guide can be formed for example by an elongated hole which is assigned to one of the two angle elements, and on the other hand by a guide pin guided in the elongated hole which is assigned to the other of the two angle elements.

As already indicated multiple times, the present invention also relates to a door arrangement for a vehicle, comprising a vehicle door which can be connected in articulated fashion to a vehicle body of the vehicle by a hinge connection, wherein the vehicle door has a recess in which a spindle drive assembly of the type according to the invention described above is partially received and is attached by its first attachment assembly, wherein the spindle of the spindle drive assembly extends from the recess through a door aperture.

Finally, the present invention relates to a vehicle comprising at least one such door arrangement of the type just described, wherein the second attachment assembly of the spindle drive assembly is attached to a vehicle body of the vehicle, in particular to an A pillar or B pillar.

Further features and advantages of the present invention will become more apparent from the following description of an embodiment thereof when considered together with the accompanying drawings. In the figures, in detail:

FIG. 1 is a plan view of a spindle drive assembly according to the invention;

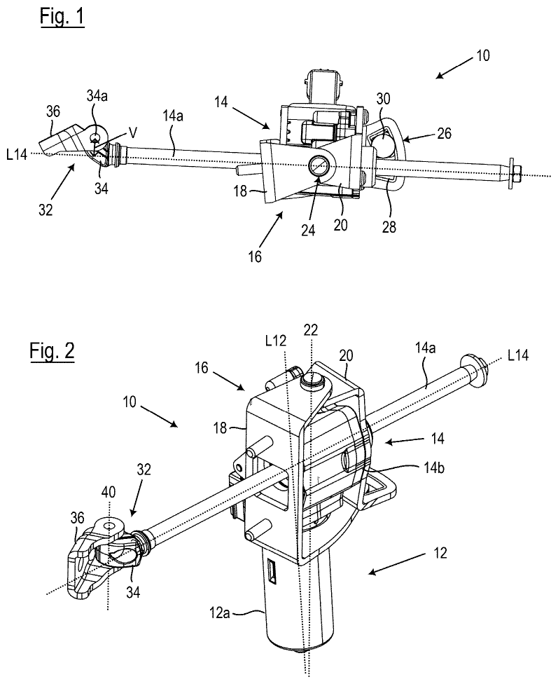

FIG. 2 is a perspective view of the spindle drive assembly of FIG. 1;

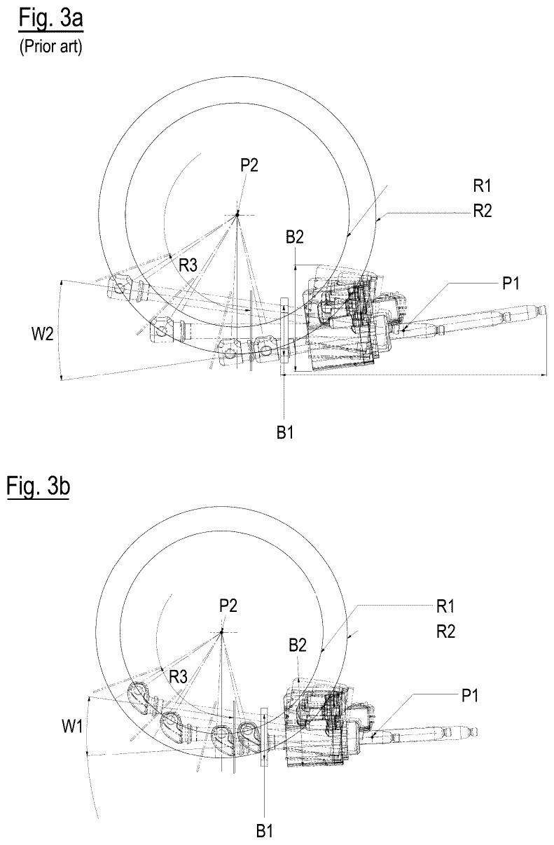

FIGS. 3A and 3B show a comparison of the pivoting kinematics of a slightly modified variant of the spindle drive assembly according to the invention from FIGS. 1 and 2 and a spindle drive assembly known from the prior art.

FIGS. 1 and 2 show a spindle drive assembly 10 according to the invention in two different views. The spindle drive assembly 10 here comprises a motor assembly 12 with a motor housing 12a, which drives a spindle 14a of a spindle assembly 14 via a worm gear (not shown) within a spindle housing 14b.

The motor assembly 12 and the spindle assembly 14 firmly connected thereto can here be attached to a first higher-level assembly via a first attachment assembly 16, wherein the first attachment assembly 16 comprises a first and a second angle element 18, 20 which can be pivoted relative to one another. It can be seen here that the corresponding pivot axis 22 of the first attachment assembly 16 substantially coincides with the longitudinal direction L12 of the motor assembly 12, or runs in its prolongation through the motor housing 12a, so that when pivoting about the pivot axis 22 the motor assembly 12 as well as the spindle housing 14b can substantially perform a largely spatially fixed rotation without moving through a considerable pivoting range.

In order to enable such stationary pivoting, the mentioned first attachment assembly 16 is constructed in such a way that it comprises a rotary joint 24 for coupling the two angle elements 18, 20, by which the pivot axis 22 is fixed, as well as a curved guide 26 which lies in a radial direction outside the motor assembly 12 and the spindle assembly 14.

In particular, in the plan view of FIG. 1 it can be seen that the curved guide 26 is formed by an elongated hole 28 and a guide pin 30 guided in the elongated hole 28, which are each assigned to the first or second angle elements 18, 20. The guide pin 30 can here be shaped and dimensioned in such a way that it achieves axial and rotational guidance in that its shape follows the curved extension of the elongated hole 28 in portions.

With regard to the connection of the spindle 14a to a second higher-level assembly, a second attachment assembly 32 is provided at one end of the spindle 14a relative to its spindle axis L14, which second attachment assembly comprises a crank 34 fixedly connected to the spindle 14a with a joint eye 34a and a connecting element 36, which are pivotally connected via a bolt (not shown as such) which accordingly defines a second pivot axis 40 of the second attachment assembly 32. In particular, it can be seen in the plan view of FIG. 1 that an offset V is provided between the spindle axis L14 and the second pivot axis 40, which offset is achieved by the crank 34.

This design of the second attachment assembly now results in the advantageous kinematics of a spindle drive assembly according to the invention, explained on the basis of FIGS. 3a and 3b, which is shown in FIG. 3b, while FIG. 3a shows a comparative example known from the prior art not having a crank in the region of the second attachment assembly. In the illustrations in FIGS. 3a and 3b, reference signs for structural components of the assemblies shown have been omitted for reasons of clarity; for this reason, in this context reference is to be made to the illustration and description in FIGS. 1 and 2.

It is to be noted that in these figures, in each case a slightly modified variant of the spindle drive assembly from FIGS. 1 and 2 is shown in multiple stroke positions, in which the first attachment assembly is designed such that the first pivot axis is located at position P1 behind the spindle assembly. Nevertheless, it can be seen that with a constant width of an aperture in the first higher-level assembly, or a region swept over by the spindle in this region, and a smaller deflection angle of the spindle, the same pivot radius can be achieved as in the comparative example from FIG. 3b, without a crank in the region of the second attachment assembly.

To illustrate this, various dimensions and positions are marked in FIGS. 3a and 3b, including the position of the door hinge axis P2, i.e. the pivot axis of the two higher-level assemblies, the vehicle body on the one hand and the vehicle door on the other, to which the motor assembly and the spindle of the corresponding spindle drive assembly are respectively attached.

Furthermore, the two FIGS. 3a and 3b each show circles R1 and R2, which illustrate the possible pivot radius around the door hinge axis P2 for the assembly according to the invention of FIG. 3b and the assembly known from the prior art of FIG. 3a, respectively. Here it will be seen that the radius R1 is significantly smaller than the radius R2, due to the position of the second pivot axis with an offset relative to the spindle axis. This in turn leads to the fact that, for the same assumed maximum door opening angle R3 of, for example, 70° in FIG. 3b, a significantly smaller deflection angle W1 of the spindle is achieved compared to the deflection angle W2 of the spindle in FIG. 3a; in the specific example shown here, W1 is 11.9° and W 2 is 16.7°.

This reduced deflection angle in turn leads to a reduced space requirement both in the region of a corresponding door aperture B1 and for the pivoting movement of the motor assembly or the spindle assembly, designated B2 in FIGS. 3a and 3b. Therefore, by the provision according to the invention of an offset between the spindle axis and the second pivot axis at the mentioned positions, a reduction in the required installation space can be achieved using structurally simple means.

1. A spindle drive assembly comprising:
a motor assembly comprising a motor shaft which can be driven in rotation by a motor and which defines a motor axis;
a spindle assembly comprising a spindle with a spindle axis, wherein the spindle is coupled to the motor shaft via a worm gear and can be driven to an extending and to a retracting movement;
a first attachment assembly which is designed to attach the motor assembly and the spindle assembly to a first higher-level assembly in a manner pivotable about a first pivot axis; and
a second attachment assembly which is arranged at one end of the spindle and is designed to attach the spindle to a second higher-level assembly in a manner pivotable about a second pivot axis;
wherein the second attachment assembly is formed such that the second pivot axis is spaced from the spindle axis by a predetermined offset.

2. The spindle drive assembly according to claim 1,
wherein the second attachment assembly comprises a crank fixedly connected to the spindle or formed on the spindle, which crank defines the second pivot axis.

3. The spindle drive assembly according to claim 2,
wherein the second attachment assembly further comprises a connecting element which is pivotally connected to the crank and is designed for attachment to the second higher-level assembly, wherein a bolt is provided for the articulation of the connecting element to the crank.

4. The spindle drive assembly according to claim 1,
wherein the predetermined offset is between 5 mm and 20 mm.

5. The spindle drive assembly according to claim 1,
wherein the first pivot axis substantially coincides with the motor axis.

6. The spindle drive assembly according to claim 5,
wherein the first attachment assembly comprises two angle elements pivotable relative to one another about the first pivot axis, a first of which is assigned to the motor assembly and the spindle assembly and a second of which is assigned to the first higher-level assembly,
wherein the angle elements are connected by means of a rotary joint which is arranged substantially in extension of the motor axis on the side of the spindle assembly facing away from the motor assembly.

7. The spindle drive assembly according to claim 6,
wherein the angle elements are further coupled via a curved guide which is arranged outside the motor assembly or the spindle assembly with respect to a radial direction perpendicular to the motor axis.

8. The spindle drive assembly according to claim 7,
wherein the curved guide is formed by an elongated hole which is assigned to one of the two angle elements, and a guide pin guided in the elongated hole which is assigned to the other of the two angle elements.

9. A door arrangement for a vehicle, comprising:
a vehicle door which can be joined in articulated fashion to a vehicle body of the vehicle by a hinge connection,
wherein the vehicle door has a recess in which a spindle drive assembly according to claim 1 is partially received and attached by its first attachment assembly,
wherein the spindle of the spindle drive assembly extends out from the recess through a door aperture.

10. A vehicle, comprising at least one door arrangement according to claim 9, wherein the second attachment assembly of the spindle drive assembly is attached on the vehicle body of the vehicle.
